(19) United States
(12) Patent Application Publication
(10) Pub. No.: US 2006/0271761 A1
(43) Pub. Date: Nov. 30, 2006

(54) Data processing apparatus that uses compression or data stored in memory

(76) Inventor: Abraham Karel RIEMENS, Eersel (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,766

(22) PCT Filed: Apr. 13, 2004
(86) PCT No.: PCT/IB04/50426

§ 371 Date: Oct. 12, 2005

(30) Foreign Application Priority Data
Apr. 16, 2003 (EP) 03101037.4

(51) Int. Cl. G06F 12/00

(52) U.S. Cl. 711/212

(57) ABSTRACT

Data, such as an image, is made up of data-items (pixels) that are each associated with a respective data address. Compressed blocks representing the data are stored in a memory system. Each block representing compressed data-items associated with data addresses in a respective sub-range of addresses of the data. Each block starts from a respective preferred starting address for multi address transfer. The sub-range of addresses of each block has a length corresponding to an address distance between the preferred starting address, leaving memory addresses not occupied by the particular block in between blocks due to compression. A decompressor is coupled between a processing element and the memory system. The decompressor starts a multi address memory transfer of a required one of the blocks from the memory system dynamically when the processing element requires access to the block, leaving memory addresses directly following the block up to a preferred starting address for a next one of the blocks untransferred in the transfer. The transferred data is decompressed and passed to the processor.

The invention relates to a data processing apparatus that uses data compression for data stored in memory.

From U.S. Pat. No. 6,173,381 a data processing system is known with a processor and a system memory that are connected via a bus. Data, such as image data, may be stored in compressed or uncompressed form in the system memory. The processor is connected to the system memory via an integrated memory controller that compresses and decompresses the compressed data when it is written to and read from the system memory. U.S. Pat. No. 6,173,381 teaches how compression is used to reduce memory occupation and bus bandwidth, because storage of data in compressed form takes less memory locations than needed for the same data in uncompressed form.

Storing data in compressed form can interfere with processing of the data, when that processing requires addressing of different locations within the data. Because of compression, and especially variable length compression, the address distances between different items in the uncompressed data are not preserved in the compressed data. U.S. Pat. No. 6,173,381 solves this problem by using a cache memory between the processor and the integrated memory controller, to store decompressed data in cache. Thus, the decompressed data can be addressed by the processor in the cache memory using virtual addresses of decompressed data. The integrated memory controller has to ensure that the compressed data is read and written at the appropriate system memory addresses during cache fetch or write back. U.S. Pat. No. 6,173,381 does not describe how the compressed data is appropriately addressed, but presumably the virtual address of decompressed data issued by the processor is translated into a physical address of the compressed form of the data, and the data is written to or read from these physical addresses. Translation of virtual addresses into physical addresses may slow down processing.

In many modern data processing systems data is retrieved in bus transfers where a block with a large number of addressable words, for example up to 64 or 128 bytes, can be transferred between memory and a processor in response to each single address. Such transfers must start from specific starting addresses (called preferred starting addresses hereinafter), for example addresses at 128 byte block boundaries (of which addresses a number of least significant bits is zero) typically at equal distance from one another, or at least additional overhead is needed if the transfer has to start from an address that is not a preferred starting address. The length of the transfer can be selected. This provides for an increase of memory bandwidth. In known processors, this number of words is not related to compression parameters.

Among others, it is an object of the invention to provide for a data processing apparatus and method in which the bus bandwidth needed for accessing data is reduced by compression without complicating access to different addressable parts of the data.

Among others, it is an object of the invention to provide for a data processing apparatus and method in which the bus bandwidth needed for accessing image and/or audio data is reduced by compression without complicating access to different addressable parts of the data.

Among others, it is an object of the invention to provide for a data processing apparatus and method in which the bus bandwidth used for processes that use decompressed data can be adapted dynamically.

The data processing apparatus according to the invention is set forth in Claim 1. The apparatus processes data-items that are each associated with a respective data address in a range of data addresses, such as pixels in an image with associated x,y addresses or temporal data associated with sampling instants tₙ. Compressed blocks are used that each represent data-items from a respective sub-range of the range of data addresses. The lengths of the sub-ranges are selected so that they correspond to the distance between pairs of preferred starting memory addresses for multi-address memory transfers. Preferably, each sub-range has the same length. The compressed blocks are stored in the memory system, each starting from a preferred starting memory address, so that the address distance to the starting memory address of the next block corresponds to the length of the sub-range of data addresses associated to the data-items in the block.

Thus, it is made possible to reduce the memory access bandwidth for storing and retrieving the blocks, by using multi-address memory transfers that are terminated when a block has been transferred. Because the distance between the starting addresses of the blocks is the same as for the uncompressed data, the starting addresses of the transfers can be determined directly from the data addresses of the required uncompressed data items, for example by taking a more significant part of the data address. As a result the range of memory addresses over which the compressed blocks are stored is substantially the same as required for the uncompressed data-items. Thus no reduction of the address range of occupied memory is realized, but only a reduction in bandwidth usage.

A processing element applies processing operations, such as filtering to these data-items. Typically, the processing element addresses the data-items with the data addresses (possibly modified with some offset), but it is also possible that the processor uses the data addresses only implicitly, for example by calling for data-items that have adjacent data addresses merely by indicating that a next data-item is needed. Preferably, decompressed data for all data addresses within the decompressed block is stored in a buffer for such retrieval, but alternatively it is possible to decompress each time only the addressed data within the block. The memory system is for example a single semi-conductor memory with attached memory bus, or any combination of memories that cooperate to supply data in response to addresses.

When the blocks of compressed data are retrieved for decompression the length of multi-address memory transfers is selected dependent on the actual block sizes. During memory transfers transfer is terminated when data from the block of compressed data has been transferred, before the data up until the start of the next block has been transferred. Thus, blocks of compressed data can be retrieved with minimum bus bandwidth and be addressed without requiring knowledge of the size of other blocks of compressed data.

The length of the sub-range of addresses of which the data is compressed together into a compressed block preferably is equal to the distance between a pair of successive preferred starting memory addresses. This enables more efficient memory bus utilisation and potentially reduces memory access latency. However, without deviating from the invention a sub-range may extend over a plurality of distances between successive preferred starting memory addresses. This provides for higher compression ratios and therefore less memory bandwidth. In this case a plurality of multi-address memory transfers may be used to transfer one block.

Information about the lengths of the blocks of compressed data is preferably stored with the blocks. Thus, these lengths automatically become available when the blocks are transferred, without requiring further memory addressing. In one embodiment length information for a block of compressed data is stored with the block itself. Thus, a signal can be generated to end the transfer on the basis of information in the block itself. In another embodiment length information for a logically next block of compressed data is stored with a block of compressed data. (by a logically next block is meant a block that is accessed next by the processing element, e.g. blocks are logically next to each other when they encode image data for adjacent image regions). Thus, length information becomes available for setting the transfer length for a block before the block is addressed. This is useful when the transfer length must be set at the start of each transfer.

Preferably a scaleable decompressing technique is used, in which the quality of decompression can be adapted by using a greater or smaller length of the block. Thus, bandwidth use can be adapted dynamically at the expense of decompression quality by adapting the length of the transfer of data from a block.

Preferably lossy compression is used, in particular when the data is intended for rendering for human perception (e.g. image data or audio data). After lossy compression the data generally cannot be reconstructed exactly by decompression, but it delivers the same perceived content to a greater or lesser extent, dependent on the compression ratio. In an embodiment, the compression ratio is adapted dynamically, dependent on the dynamically available memory bandwidth.

In another embodiment different decompression options are available, that reconstruct the data with increasingly less accuracy, using different increasingly less data, so that by terminating memory transfers sooner and less bandwidth may be used at the expense of less accuracy.

These and other objects and advantageous aspects of the invention will be described using the following figures.

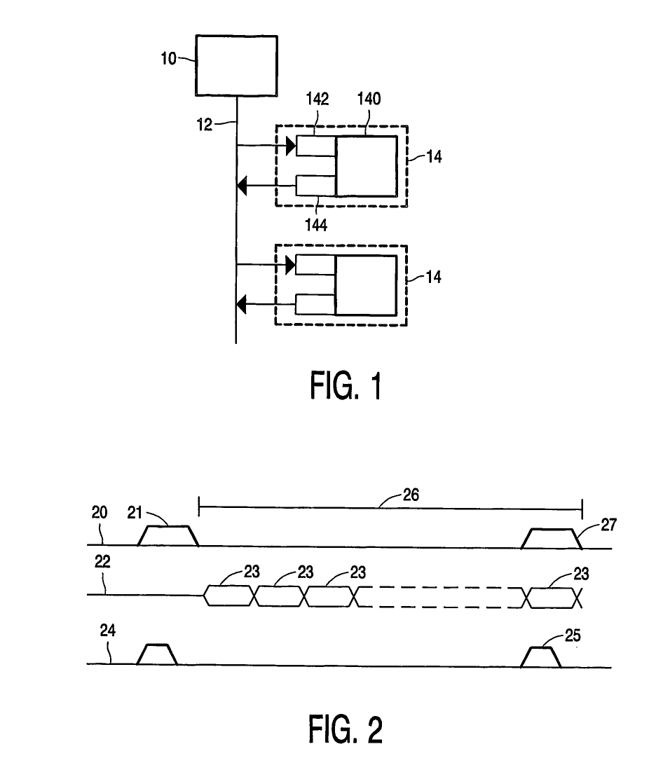

FIG. 1 shows a data processing apparatus

FIG. 2 illustrates memory access

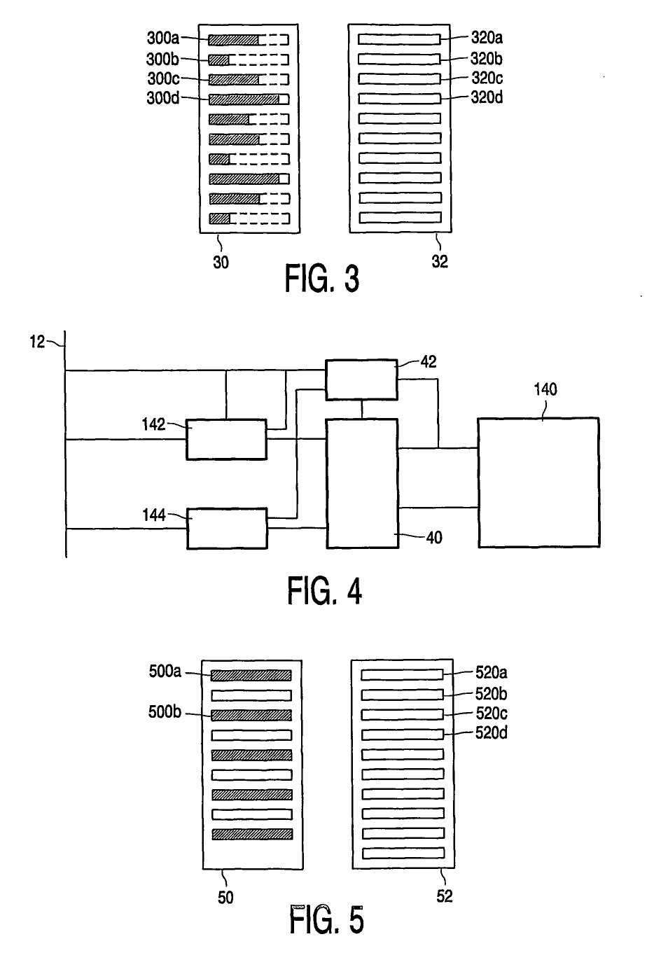

FIG. 3 shows memory occupation

FIG. 4 shows a processing element

FIG. 5 shows memory occupation

FIG. 1 shows a data processing apparatus with a memory 10, and a number of processing elements 14 (only two shown by way of example) interconnected via a bus 12. The processing elements 14 contain a processor 140, a decompressor 142 and a compressor 144. Processor 140 is coupled to bus 12 via decompressor 142 and compressor 144. In the context of the present application memory 10 and bus 12 said to be part of a memory system that provides access to data in memory 10.

FIG. 2 illustrates a memory transfer involving memory 10 via bus 12 during operation of the apparatus of FIG. 1. By way of example, FIG. 2 illustrates a separate address signal 20, a data signal 22 and an end signal 24. In order to read or write data from or to memory 10, processing element 14 first outputs a block address 21 in address signal 20. Subsequently a number of words of data 23 is transferred for the block address 21. In case of a read operation words of data 23 are data words from successive memory locations with addresses starting from the block address 21. In case of a write operation words of data 23 are data words from processing element 14 that have to be written in successive memory locations with addresses starting from the block address 21.

After transfer of a number of words of data 23 processing element 14 generates an end signal 25 indicating the termination of the memory transfer for the block address 21, and availability of bus 12 for a next memory transfer at a next block address 27. Thus, data words 23 are transmitted during a time-slot 26, the length of which is controlled by processing element 14. (It will be appreciated that in the actual implementation types of signals may be used that differ from address signal 20, data signal 22 and/or end signal 24, but represent the same information. For example, the end signal may be represented by a length code transmitted at the start of the transfer).

FIG. 3 shows actual memory occupation 30 in memory 10 and virtual memory occupation 32 as seen by processors 140. Memory 10 is shown organized into blocks 300a-d, the blocks 300a-d being shown one above the other. The length of the blocks corresponds to the number of words between successive locations that can be addressed by different block addresses 21. Typically, the length is a power of 2, for example 64 words or 128 words per block.

In one embodiment, a memory 10 (known per se) is used, which is constructed so that multi-address memory transfers can start only from block boundary addresses, e.g. from addresses that are 128 bytes or 256 bytes apart, of which the last 7 or 8 bits of the address are zero. In response to a request for a multi-address memory transfer, the memory internally generates signals that effect the equivalent of successively addressing locations in the memory whose addresses have different values of the less significant bits of the address. The architecture of such memory systems is designed to deliver optimal performance (in terms of bus utilization and latency) for this type of accesses from the start of a line. This applies both to reading and writing. The starting addresses in this embodiment will be referred to by the term “preferred starting addresses”, although in fact they are in fact the only possible starting addresses for multi-address memory transfers.

In another embodiment a memory (known per se) is used which is constructed so that the least significant part of the starting address of a multi-address memory transfer may optionally be used to select the starting address of the multi-address memory transfer, at the expense of at least an additional memory clock cycle. In this case, a signal is sent to memory 10 not to use this additional clock cycle, but to start the multi-address memory transfer immediately from a standard starting address with minimum overhead, without using one or more additional clock cycles for an adapted starting address. The term “preferred starting address” will be used to refer to these standard addresses in this embodiment. Of course, both embodiments may have further embodiments in which a maximum transfer length may be imposed by the distance between successive preferred starting addresses, so that a new multi address transfer has to be started for each preferred starting address if a block to be transferred extends over more than one starting address, but the invention is not limited to such further embodiments.

Preferably, the compression block size is selected so that the address distance between successive blocks of uncompressed data is equal to the distance between a pair of preferred starting addresses for a multi-address memory transfer. In many compression algorithms the block size can be adjusted, or compression blocks can be combined into larger blocks so that the required block size, as defined by the memory architecture can be realized. As discussed in the following, compression block size may alternatively be set to an integer multiple of this memory system block size. When the compressed data from the blocks is decompressed each block of decompressed data has a length corresponding to the distance between a pair of preferred starting addresses in memory 10. Preferably all blocks of decompressed data have the same length.

Those memory locations in actual memory occupation 30 that are occupied by compressed data are shown as hatched areas. As shown in actual memory occupation 30, varying parts of memory transfer units 300a-d are left unoccupied by compressed data, when variable length compression is used.

A processing element 14 contains a decompressor 142 and a compressor 144. Decompressor 142 retrieves compressed data from memory 10 via bus 12 by supplying a block address 21 of a block of compressed data and generating an end signal 25 to terminate the memory transfer when all the compressed data from the addressed block has been transferred, but before the content of the entire physical memory transfer unit has been transferred. Decompressor 142 decompresses the retrieved data from the addressed block and supplies the decompressed data to processor 140.

Similarly, compressor 144 compresses data produced by processor 140 and writes the compressed data to memory 10 via bus 12. In this case compressor 144 supplies a single block address 21 for a block of compressed data, transmits the words of compressed data from the compressed block and sends a signal to terminate transfer for the block address 21 when the number of words that represents the compressed data has been transmitted, before all words in the physical memory transfer unit have been overwritten.

Processor 140 addresses data in the blocks in terms of addresses of decompressed data. That is, the data address is generally composed of a block address of a decompressed block and a word address within the decompressed block. The word address can assume any value up to the predetermined decompressed block size. Thus, to processor 140, the address space appears as shown in virtual memory occupation 32, wherein each block 320a-d occupies the same predetermined number of locations. When processor 140 issues a read request it supplies the data address to decompressor 142. Unless the addressed data has been cached, decompressor 142 uses the block address part of the data address to address memory 10 via bus 12. Subsequently, decompressor 142 retrieves from the addressed block the actual number of words that is needed to represent the compressed block the memory transfer being terminated once this actual number has been transferred, but generally before the full predetermined length of the block has been transferred. Decompressor 142 decompresses the retrieved data, selects the data addressed by the data address from processor 140 and returns the selected data to processor 140.

Preferably, decompressor 142 contains a buffer memory (not shown separately) for storing data for all data addresses of the decompressed block. When the block is decompressed decompressed data is written to all these locations and the data addressed by processor 140 is provided to processor 140 from these locations. Alternatively, each time only the addressed word from the data may be decompressed or a subset of the words including the addressed word. Generally it will require little additional effort to decompress all words of a block instead of just one word, by buffering all words access latency is decreased on average. However, it should be understood that in an embodiment the compressed block may be made up of sub-blocks that can be decompressed independently of one another. In this case the decompressed data for one sub-block may overwrite the data of another sub-block from the same block in the buffer memory, when data from the one sub-block is needed, without fetching of new a block from memory system 10.

When processor 140 writes data, processor 140 supplies for the write data a data address that is used by compressor 144. Typically, compressor 144 stores data from a complete uncompressed block, uses the write data to replace this uncompressed data at the address that is addressed by the data address, later compresses the data and writes the compressed data to memory 10 using the block address from the data address used by processor 140. Compressor 144 terminates the transfer when the compressed data for the block address has been transferred, generally before the predetermined number of words has been transferred to memory 10 that corresponds to the distance between successive block addresses.

As a result, when processor 140 addresses substantially the entire decompressed data the number of words that has to be transferred via bus 12 between processing element 14 and memory 10 is smaller than the total number of words in the decompressed data, leaving more bus and memory bandwidth for other transfers. The memory space occupied by compressed data is generally not reduced by using compressed data, since unoccupied space is left behind each compressed block in memory 10, to permit used block addresses of decompressed blocks to be used as block addresses for retrieving compressed blocks.

In one example, a compressed video image is stored distributed over a plurality of successive compressed blocks in memory. After decompression, processor 140 addresses pixels of this image individually. In this case the distance between the lowest and highest address of the memory locations occupied by the compressed image is substantially the same as that needed for storing the uncompressed image, again because the unused memory locations are left at the end of each compressed block 300a-d. In this case, a video display device, such as a television monitor may be coupled to memory 10 via a decompressor and bus 12, or a video source, such as a camera or a cable input may be coupled to memory 10 via a compressor and bus 12.

Compressor 144 and decompressor 142 preferably make use of variable length compression, which adapts the length of the compressed data in each compressed block to the particular uncompressed data in the block. This makes it possible to minimize memory and bus bandwidth use.

In case of image data or other sensory data such as audio data lossy compression may be used, which compresses the data at the expense of some information loss. This also makes it possible to minimize memory and bus bandwidth use. In an embodiment the compression ratio (and thereby the amount of loss) is dynamically adapted to the dynamically available bus bandwidth. In this embodiment a bus monitor device (not shown) may be coupled to bus 12 to determine the bandwidth use. This can be realized for example when processing elements 14 are designed to send signals to the bus monitor to indicate a requested bandwidth use, or when the bus monitor counts the number of unused bus cycles per time unit The bus monitor is coupled to compressor 144 to set the compression ratio in compressor 144, either dynamically, or in response to a request from a processing element 14 to start writing compressed data.

Preferably, compressor 144 includes a length code in each block of compressed data, to indicate the number of words in the block of compressed data. The length code is included for example in a first word of the compressed block, preceding the compressed data. Thus the format of a block is
(length code of block, compressed data)
   When decompressor 142 uses a block address to retrieve a compressed block, decompressor 142 reads the length code from the compressed block and uses the length code to signal to memory 10 after how many words the memory transfer for the block address may be terminated.

As an alternative, compressor 144 may be arranged to store the length code for each particular compressed block in a preceding and/or succeeding compressed block adjacent to the particular compressed block in memory 10.
(length code of preceding and/or succeeding block, compressed data)
   In this case, decompressor 142 has to read the preceding or succeeding block first to determine the number of words that has to be included in the memory transfer. Because blocks are mostly transferred in the order in which they are stored in memory, decompressor 142 may usually avoid additional memory transfers to retrieve the length code by retaining the length code from a compressed block to control the length of the memory transfer for a next fetched compressed block. This makes it possible to supply the length code at the start of the memory transfer. Usually, data is accessed only in one address direction. In this case, it suffices to store in each particular compressed block the length code for the adjacent block in this one direction. In another embodiment, length codes for adjacent blocks in both directions are included to avoid separate reading of the length codes when reading in either direction. When this process of successive transfers is started, the length of the first block is unknown. In such cases, the whole uncompressed length may be transferred which yields a small penalty for the first transfer only.

In yet another embodiment the particular compressed block for which the length code is included with a specific compressed block in memory 10 may be adapted to the expected way of addressing blocks successively: for example if it is expected that each second decompressed block will be skipped, the length codes of the second next compressed block is included with each a block. In a further embodiment a next block code is included with the block to indicate the logically following block for which block the length code is included. The block format is now for example

| | |
|---|---|
| ( | code identifying logically following block, |

length code of logically following block,
compressed data for current block
)

In an embodiment where compressed image data is stored for example, it may be desirable to skip every second image line when an interlaced image is accessed. Accordingly the length code at the end of each image line may be arranged to describe the number of compressed words for the start of the second next image line.

FIG. 4 shows an embodiment of a processing element with a cache memory 40 and a cache management unit 42. Cache memory 40 is coupled between processor 140 on one hand and compressor 144 and decompressor 142 on the other hand. In operation, cache memory 40 stores one or more blocks of decompressed data, plus information about the address of the cached blocks. When processor 140 addresses data from cached blocks no access to bus 12 is needed. When processor 140 addresses data that is not in cache memory 40, cache management unit 42 triggers decompressor 142 to retrieve the compressed block from which the addressed data can be retrieved after decompression. Decompressor 142 decompresses the retrieved block and writes the decompressed block to cache memory, so that it may subsequently be addressed.

If necessary cache management unit 42 creates room in cache memory 40 by reusing cache memory space used for a previous block of uncompressed data. When processor 140 has updated data in this block, cache management unit first signals compressor 144 to compress the uncompressed block and to write the compressed block to memory 10 (not shown). Various conventional cache write back strategies may be used, such as write through (compressing and writing each time when processor 140 updates a data word in cache memory 40), or write back (only when cache space for a new uncompressed block is needed).

It may be noted that upon writing a block of compressed data to memory 10, compressor 144 generally needs the entire block of decompressed data, even if only one word has been updated by processor 140. Hence, in order to write a data word it may be necessary to retrieve the block of compressed data from memory 10, to decompress the block of compressed data (preferably using decompressor 142), to update the relevant data word or words in the block of decompressed data, to compress the updated block and to write back the compressed block. However, usually a number of different data words of the uncompressed block is updated successively. Preferably write back occurs only when processing of the uncompressed block has been completed. Often, moreover, all data in the decompressed block is updated, so that no decompression of an old block is needed.

In an embodiment, compression and decompression is optional. In this embodiment both compressed and decompressed blocks may be stored in memory 10. Selection whether to compress or not may be performed by processor 140, for example by setting a compression control register (not shown) or by selecting compression and no compression when the data address in within and outside a predetermined range of addresses respectively. In case of uncompressed data compressor 144 and 142 are effectively bypassed, for example for data addresses outside one or more specific address ranges. A bit from the data address may used for example to indicate whether the address in or outside a range where compressed or uncompressed data is addressed.

In another embodiment, decompressor 142 is arranged to use one of a series of different compression options that are each capable of obtaining decompressed information from the same compressed data, but using increasingly smaller subsets of the decompressed data. In the memory, for each block of compressed data, data from the smallest subset is placed first, followed each time by the additional data needed to complete the next larger subset. For example, when the block is coded in terms of a series of numbers, words containing more significant bits of the numbers for the block may be placed first in memory, followed by words containing less significant bits, these, if applicable being followed by words with even less significant bits and so on. However, it should be appreciated that other possibilities exist, such as placing numbers that represent a subsampled subsets of the block first etc. The different compression options read increasingly larger subsets of the block of compressed data, with which the decompressor is able to regenerate increasingly higher quality decompressed data. When a certain decompression option is used, the decompressor terminates memory transfer when the relevant subset of the data has been transferred. The required length of the transfer is computed from the option used and, if applicable from a length code for the block (e.g. when more significant bits are used, the number of bits to be transferred follows from the length (the number of numbers in the block) times the fraction of more significant bits that is used). Thus bandwidth use on bus 12 is minimized.

Thus, less bus 12 bandwidth use can be realized by using decompression of increasingly lower quality. Dependent on the needs of the algorithm executed by processor 14, processor 14 selects one of the decompression algorithms and commands decompressor 142 to use the selected decompression algorithm. Thus, bandwidth use is adapted to the needs of processor 14. Also a bus manager (not shown) may be provided to determine bus bandwidth use in bus 12 (any known way of determining bandwidth use may be employed) and to send a signal to select the decompression algorithm dependent on the available bandwidth on bus 12.

In addition to data cache 40 the processing element may be provided with an instruction cache (not shown) for processor 140. Preferably, the instruction cache has a separate interface to bus 12. Instructions are preferably read without decompression, so as to minimize latency and cache managed separate from the decompressed data.

In the preceding it has been described how successive compressed blocks are stored at address distances that correspond to the distance between the starting data addresses of the decompressed blocks that correspond to the compressed blocks. Preferably, the distance corresponds to the distance between a pair of successive preferred starting addresses as defined by the memory system architecture for starting a multi-address memory transfer via bus 12 in response to a single block address. However, in a further embodiment the distance corresponds to an integer multiple of this distance, i.e. to the distance between a pair of preferred starting addresses that are separated by other preferred starting addresses. If the maximum multi-address transfer length is limited by the distance between successive preferred starting addresses, the entire memory space available for a compressed block in this case cannot be addressed by a single block address 21. This means that in principle a plurality of block addresses 21 may need to be supplied to access a compressed block. Dependent on the compression ratio one or more of these block addresses may be omitted when the compressed block is transferred and/or a final number of data words that is accessible with a supplied block addresses may not need to be transferred.

It should be realized in this context that although the words “block of compressed data” refer to a collection of data that can be decompressed without reference to other blocks, it is not implied that all data from the compressed block is needed to decompress any word in the block. For example, a block of compressed data may comprise a number of sub-blocks of compressed data that can be decompressed independently. Similarly, if variable length coding, such as Huffmann coding, is used it may be necessary to consult data for other words only to determine the starting point of the word for a particular address of uncompressed data.

FIG. 5 shows an example of physical memory occupation 50 that makes use of a greater distance between starting addresses of blocks. In this example the compression ratio is two. As a result decompressed data 520a,b that would require two block addresses for transfer can be stored as compressed data in memory spaces 500a,b (shown as hatched areas) with a size that can be transferred with one block address each. Every other memory space of this size (shown as not-hatched area) is not occupied by compressed data and its content need not be transferred. Thus the number of block addresses that needs to be supplied to memory 10 will be halved. It will be understood that for other factors of compression other number of memory spaces may be left open.

In principle the memory intermediate spaces left open to facilitate addressing with addresses in decompressed blocks may be empty of relevant data. However, without deviating from the invention other data may be stored in these intermediate spaces for use by other processes. Also copies of compressed data from other blocks may be stored in these intermediate spaces. In this case a lookahead can optionally be realized in some operations by loading data from the entire space between preferred addresses. But, of course this data in the intermediate spaces does not continue past the next preferred starting address where a next block of compressed data starts.

Furthermore, it should be understood that part of the decompressed data may be dummy data which is not dependent on the compressed data. As a result the number datawords that are actually obtained using decompression from compressed data that is stored between two block addresses may in fact be smaller than the number of datawords between these two block addresses. Moreover, although the blocks of compressed data (optionally including length information) preferably start immediately from the preferred starting addresses, it will be understood that, without deviating from the invention an offset may be used. In this case the preferred starting is still the starting address of the multi-address memory transfer, but some transferred data from the start of the transfer may be left unused for decompression. Similarly, it is possible to offset the end address of the multi-address transfer somewhat beyond the last address of the compressed block. A bandwidth gain is still realized as longs as the transfer is terminated leaving some data up to the next preferred starting address untransferred.

Although the invention has been described in terms of processing elements that supply addresses of uncompressed data explicitly and compressors and decompressors that use the addresses supplied by the processing elements to address compressed blocks in memory, it will be appreciated that processing elements may address the data implicitly, for example by signalling “next” to the compressor or decompressor to indicate a change of address to an adjacent address (e.g. a pixel to the right or a later sample of a temporal signal). The invention is advantageous not only because addresses of uncompressed data can be translated into memory addresses of blocks of compressed data directly, but also because no data for unneeded blocks needs to be fetched that would have to be discarded in case of random access. No administration needs to be kept about the starting points of different blocks.

Although the invention is preferably applied to compressed blocks that each represents data in a same sized sub-range of addresses of uncompressed data, it will be understood that without deviating from the invention different sized subranges may be used for different blocks.

1. An apparatus for processing data-items each associated with a respective data address in a range of data addresses, wherein compressed blocks representing the data items are stored in a memory system, memory addresses occupied by each block starting from a respective preferred starting address for multi address transfer of the memory system, each block representing compressed data-items associated with data addresses in a respective sub-range of the range, the sub-ranges being successively contiguous, each particular sub-range having a length corresponding to an address distance between the preferred starting address from which addresses of the particular block that represents the data-items in the particular sub-range start and the preferred starting address from which addresses of a next one of the blocks for a next successive sub-range start, leaving memory addresses not occupied by the particular block in between blocks, the apparatus comprising
the memory system, which is capable of performing selectable length multi-address memory transfers starting from the preferred starting addresses only, or with less overhead than starting from other addresses than the preferred starting addresses;
a processing element for processing the data-items;
a decompressor coupled between the processing element and the memory system, the decompressor being arranged to
start a multi address memory transfer of a required one of the blocks from the memory system dynamically when the processing element requires access to the block, leaving memory addresses directly following the block up to a preferred starting address for a next one of the blocks untransferred in the transfer, and to
decompress the data-items from the required one of the blocks before passing the data-items to the processing element.

2. An apparatus according to claim 1, wherein the processing element is arranged to indicate, to the decompressor, a decompression option selected from a series of different decompression options that require successively less addresses starting from the preferred starting address of the required one of the blocks to be transferred, the decompressor setting the length of the memory transfer dependent indicated decompression option.

3. An apparatus according to claim 1, wherein the decompressor is arranged to send a signal to the memory system to terminate the multi-address memory transfer of the required one of the blocks when a number of words, selected dependent on the length of the required one of the blocks, has been transferred.

4. An apparatus according to claim 3, wherein the decompressor is arranged to retrieve information representing the length of the required one of the blocks from the multi address memory transfer, the decompressor generating the signal dependent on said information.

5. An apparatus according to claim 1, wherein the decompressor is arranged to
retrieve information representing the length of the required one of the blocks from a multi address memory transfer of a precedingly retrieved block, retrieved preceding the required one of the blocks and to
send a transfer length selection signal to the memory system derived from the information at the start of the multi address memory transfer for the required one of the blocks.

6. An apparatus according to claim 1, wherein the lengths of the sub-ranges are mutually equal and larger than a distance between successive preferred starting addresses, the decompressor being arranged to start subsequent multi-address memory transfers for the required one of the blocks conditionally dependent on the length of the block.

7. An apparatus according to claim 6, wherein each block comprises a plurality of sub-blocks that are decompressible independently of one another, each sub-block corresponding to a respective equal sized part of the sub-range for the block, the decompressor comprising a buffer memory region, for buffering the sub-blocks of compressed data read during the multi-address memory transfer, an intermediate memory region for storing data decompressed from the sub-blocks successively, the decompressor replacing the decompressed data from respective sub-blocks read during the memory transfer with one another successively in the intermediate memory.

8. An apparatus according to claim 1, wherein the decompressor is arranged to apply decompression corresponding to lossy block compression.

9. An apparatus according to claim 1, wherein the decompressor is arranged to apply decompression corresponding to variable length block compression.

10. An apparatus according to claim 1, wherein the sub-ranges have mutually equal lengths.

11. An apparatus according to claim 1, comprising a compressor for compressing the data items associated with respective ones of the sub-ranges that has a length equal to the distance between a pair of preferred starting addresses, the compressor compressing the data items associated with a respective one of the sub-ranges each into a respective one of the blocks, the compressor being arranged to store the compressed blocks into the memory system using a respective multi-address memory transfer for each respective one of the blocks, each transfer starting from a respective one of the preferred starting addresses, the decompressor terminating the multi-address memory transfers upon completion of storing each block, without writing up to a next preferred starting address when not required for the block.

12. An apparatus according to claim 11, wherein the processing element computes the data-items for compression and the compressor is arranged to receive the data items for compression from the processing element.

13. An apparatus according to claim 11, wherein the compressor is arranged to adapt a compression ratio for compression of the data dependent on a dynamically measured level of available bandwidth for access to the memory system.

14. A method of processing a set of data-items, in which each data-item is associated with a respective data address in a range of data addresses, the method comprising
providing a memory system that has memory addresses comprising a subset of equidistant preferred starting addresses from which multi-address memory transfers can be started exclusively, or with less overhead than from other addresses than the preferred starting addresses;
storing compressed blocks in the memory system, addresses used for each respective one of the blocks starting from a respective one of the preferred starting addresses, each block representing compressed data-items associated with data addresses in a respective sub-range of the range, the sub-ranges being successively contiguous, each particular sub-range having a length corresponding to an address distance between the preferred starting address from which the particular block that represents the data-items in the particular sub-range starts and the preferred starting address from which a next one the blocks for a next successive sub-range starts, leaving memory addresses not occupied by the particular block in between.

15. A method according to claim 14, comprising
processing decompressed data-items derived from the blocks;
retrieving a required one of the blocks from the memory system for said processing, by means of a multi-address memory transfer starting from the preferred starting address starting from which the required one of the blocks is stored;
terminating the multi-address memory transfer for the required one of the blocks according to a length of the required one of the blocks, leaving content of memory addresses directly following addresses used for the required one of the blocks untransferred.

16. A method according to claim 14, comprising storing information representing a length of the required one of the blocks with the required one of the blocks in the memory system for transfer in the multi-address memory transfer.

17. A method according to claim 14, comprising storing information representing the length of the required one of the blocks with a logically preceding one of the blocks from which data-items are normally processed during said processing preceding data-items from the required one of the blocks, for transfer in a multi-address memory transfer for the logically preceding one of the blocks.

18. A method according to claim 17, comprising
reading the information from the logically preceding one of the blocks;
sending a transfer length selection signal selected dependent on the information to the memory system at the start of the multi address memory transfer for the required one of the blocks.

19. A method according to claim 14, wherein lossy block compression of uncompressed data is used to generate the blocks.

20. A method according to claim 14, wherein variable length block compression of uncompressed data is used to generate the blocks.

21. A method according to claim 20, wherein a compression ratio of the variable length block compression is dynamically adjusted according to dynamically available bandwidth for access to the memory system.

22. A computer program product comprising machine instructions for controlling memory transfers and decompression according to the method of claim 14.
